(19) United States
(12) Patent Application Publication
(10) Pub. No.: US 2014/0037102 A1
(43) Pub. Date: Feb. 6, 2014

(54) HEADPHONE, EARPHONE OR EAR BUD SYSTEM

(71) Applicant: BLANCA DIANYRA ALANIS, EDINBURG, TX (US)

(72) Inventor: BLANCA DIANYRA ALANIS, EDINBURG, TX (US)

(21) Appl. No.: 13/955,099

(22) Filed: Jul. 31, 2013

Related U.S. Application Data
(60) Provisional application No. 61/679,011, filed on Aug. 2, 2012.

(51) Int. Cl. H04R 1/10

(52) U.S. Cl. CPC H04R 1/1041
USPC 381/74

(57) ABSTRACT

A headphone, earphone or ear bud system features headphones, earphones or ear buds attached to retractable cords in combination with a retractable cord with a jack for connection to a sound generating device. A device for retracting the cords attached to the headphones, earphones or ear buds, and a device for retracting the retractable cord with a jack are both fixed to a lanyard or necklace that can be worn around the neck of a user of the device.

This is a nonprovisional application that claims priority of provisional U.S. patent application 61/679,011 filed 2 Aug. 2012 which is incorporated herein by reference in its entirety.

### FIELD OF THE INVENTION

The present invention relates to a device that provides an improved headphone, earphone or ear bud system to overcome problems encountered with prior art earphone or ear bud systems.

### BACKGROUND OF THE INVENTION

In an evaluation of many headsets and earphones ranging from the cheapest to the most expensive; no prior art headset/earphones/ear buds were identified that did not have the following problems. If an electronic device is placed in a pocket, the spool ends up at the middle of the user's torso with no place to clip it, and it pulls the ear buds out of the user's ears. A user may not be able to sit using a personal computer comfortably because the cord associated with the prior art headset/earphones/ear buds is not longer than 3½ feet. It is impressive how the cords of prior art headset/earphones/ear buds tangle in a matter of seconds. The untangling usually results in the damaging of the cord. Traveling with more than one person is a constant fight to see who will get to plug in their headphones/earphones first to watch a movie or listen to an electronic device. Carrying an adapter is a great idea until it becomes misplaced. Sharing the prior art headset/earphones/ear buds is exasperating because the cord is so short that one person is practically overlapping the other. Needless to say how unsanitary that is. Working out is a constant stress, because of the interfering of the cord. It always happens that one set of prior art headset/earphones/ear buds has one good quality but is lacking a fine quality that another headset has. What is needed is a device that provides new headset/earphones/ear buds that overcome the shortcoming of the prior art.

### SUMMARY OF THE INVENTION

There is provided in accordance with the present invention an improved device for listening to sounds using headphones, earphones or ear buds wherein the device: is easy to use; free of tangles; includes an adapter that allows the sharing of music with others without having to share ear buds/earplugs; includes exchangeable ornamental members for an everyday use wherein the ornamental members are conveniently secured to the device magnetically; is cell phone compatible; includes a control for volume and balance of sound to left and right speakers; wherein the speakers (headphones, earphones, or ear buds) are retractable either together or individually; a long head jack cord may be used to connect the device to a source of audio signals such as an I Pod®; and a lanyard that includes signal conductors is of a comfortable and functional length.

### BRIEF DESCRIPTION OF THE DRAWINGS

FIG. 1 is a pictorial representation of an exemplary device of the present invention.

FIG. 2 is a pictorial representation of a slide assembly of the device of FIG. 1 having a cord retractor mechanism.

FIG. 3A is an enlarged pictorial representation of exemplary earphones that are components of the device of FIG. 1.

FIG. 3B is an enlarged pictorial representation of an exemplary earbud that may be a component of the device of FIG. 1.

FIG. 3C is a pictorial representation of alternate sizes of exemplary earbuds that may be a component of the device of FIG. 1.

FIG. 4 is a pictorial representation of a portion of a side of the device of FIG. 1 that is located at the back of a users' neck showing a side of the device that is distal from the users' neck.

FIG. 5A is a pictorial representation of the inside of an exemplary cord retraction mechanism of the device of FIG. 1.

FIG. 5B is a pictorial representation of an exemplary ornamental member of the device of FIG. 1.

FIG. 5C is a pictorial representation of more details of an exemplary cord retraction mechanism of the device of FIG. 1.

FIG. 6 is another pictorial representation, partially broken away, of the device of FIG. 1.

FIG. 7 is a pictorial representation of an exploded view of the cord retraction mechanism of the device of FIG. 1.

### DETAILED DESCRIPTION OF THE INVENTION

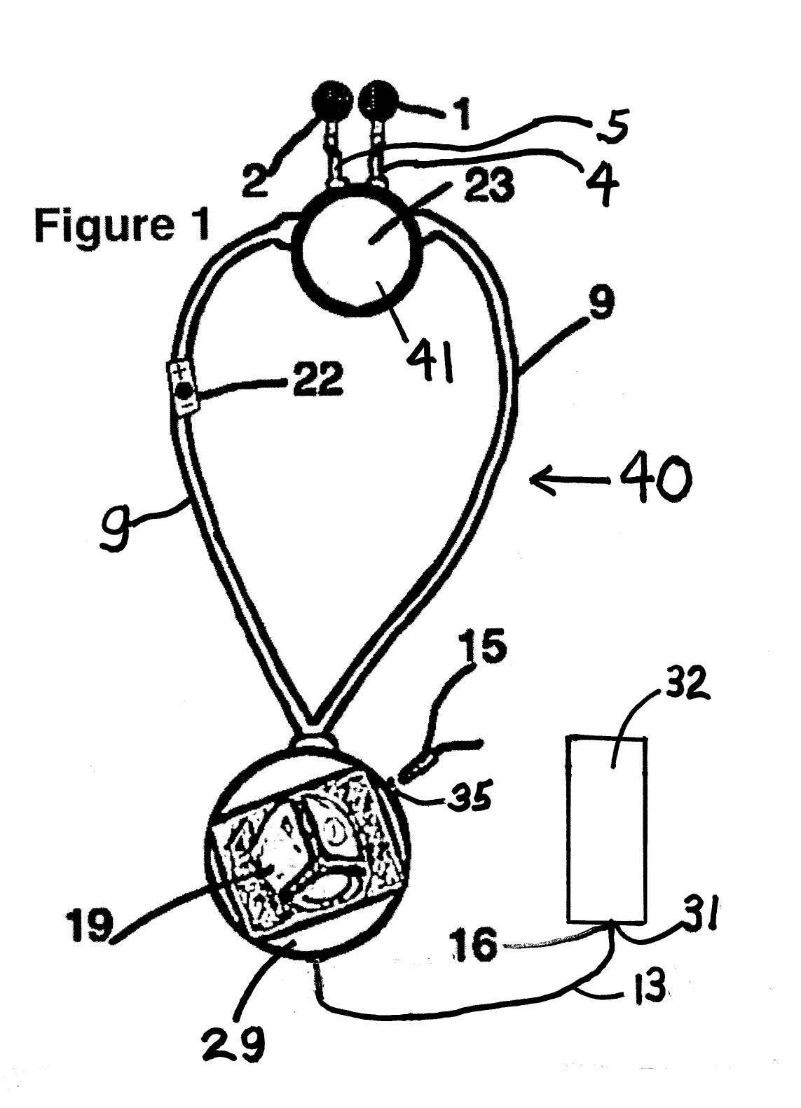

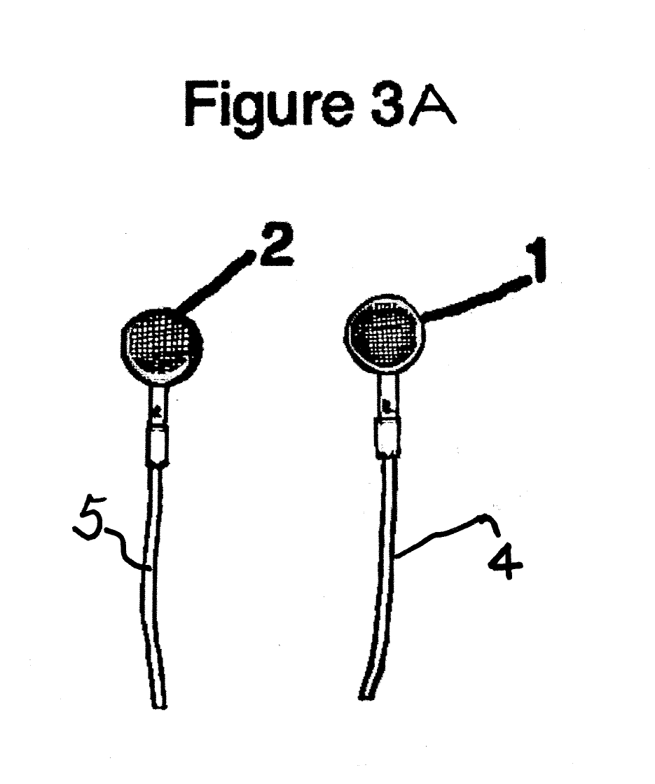

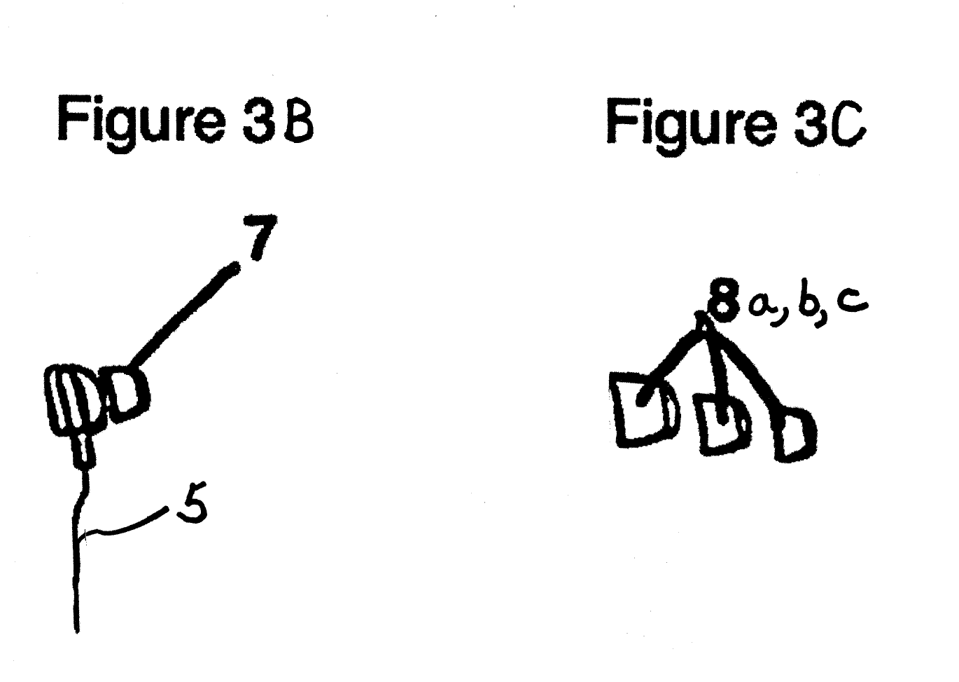

Referring first to FIG. 1 there is shown a pictorial representation of an exemplary device 40 for transmitting sounds to at least one ear of a listener according to the present invention. A mechanism 29 for receiving audio signals is fixed to a lanyard 9 provided with conductors for transmitting audio signals to an audio signal relay mechanism 41 that relays audio signals to audio signal conducting cords 4, 5 which communicate with earphones 1, 2. Enlarged representations of the earphones 1, 2 are shown in FIG. 3A. As used herein and in the claims the term “earphone” is understood to have its common meaning of a device that converts electric signals, as from a telephone, stereo, or radio receiver, to audible sound and fits over the ear of a listener. It is understood that a device of the present invention may be provided with at least one earbud, with an exemplary earbud shown in FIG. 3B. As used herein and in the claims the term “earbud” is understood to have its common meaning of a device that converts electric signals, as from a telephone, stereo, or radio receiver, to audible sound and fits in the ear of a listener. As shown in FIG. 3C earbuds 8 a, b, c of a variety of sizes may be used in the practice of the present invention. The earbuds 8a, b, c come with a double flanged design that provides a gradual sizing from small to large. The device of the present invention may be provided with circuitry to provide that music will automatically pause at the occurrence of a selected event, such as a telephone call and then resume after the event is over.

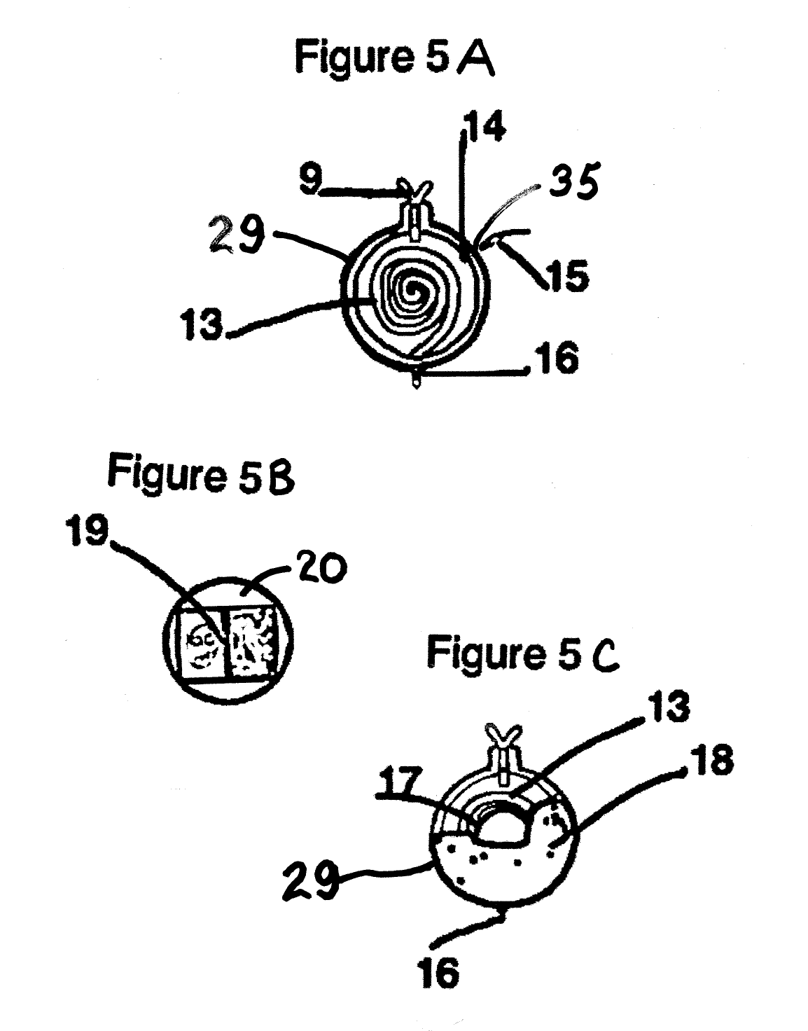

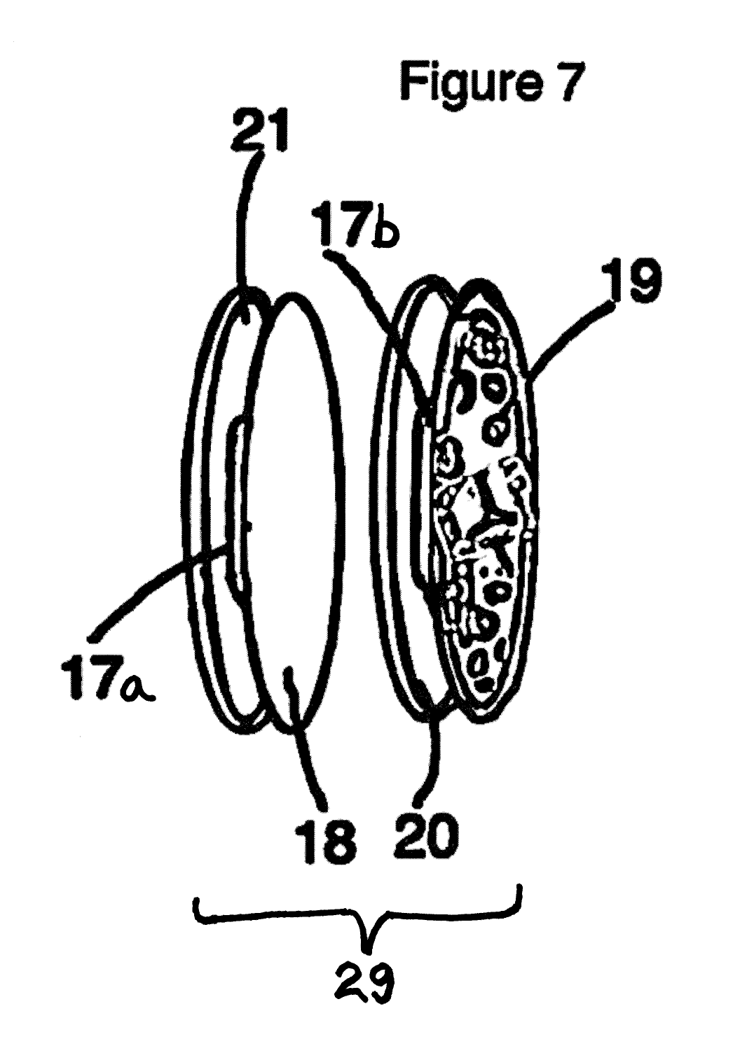

The mechanism 29 for receiving audio signals is best understood by referring to FIGS. 5A-5C and 7. A housing of the mechanism for receiving audio signals includes a back cover 21 and a front cover 18 that is a thin plastic member. A first magnet 17a is located inside the housing. A mounting member 20 is associated with a second magnet 17b that is oriented to be magnetically attracted to the first magnet 17a to secure an ornamental article 19 to the front of the housing. The ornamental article may be removed and replaced by another suitable ornamental article provided with a magnet at the prerogative of a user of the device 40 for transmitting sounds to at least one ear of a listener. It is envisioned that when marketing the device of the present invention only one ornamental article/gadget will be included in each package. The ornamental articles/gadgets are lightweight, magnetic and have a thin body with stable fitting. The ornamental article/gadgets are lightweight, magnetic and have a thin body with stable fitting. By simply placing the lanyard/necklace under the shirt and placing the magnetic ornamental article/gadget on top it will prevent the device from interfering with any workout. It is understood that if desired the ornamental article could be permanently fixed to the housing of the mechanism for receiving audio signals.

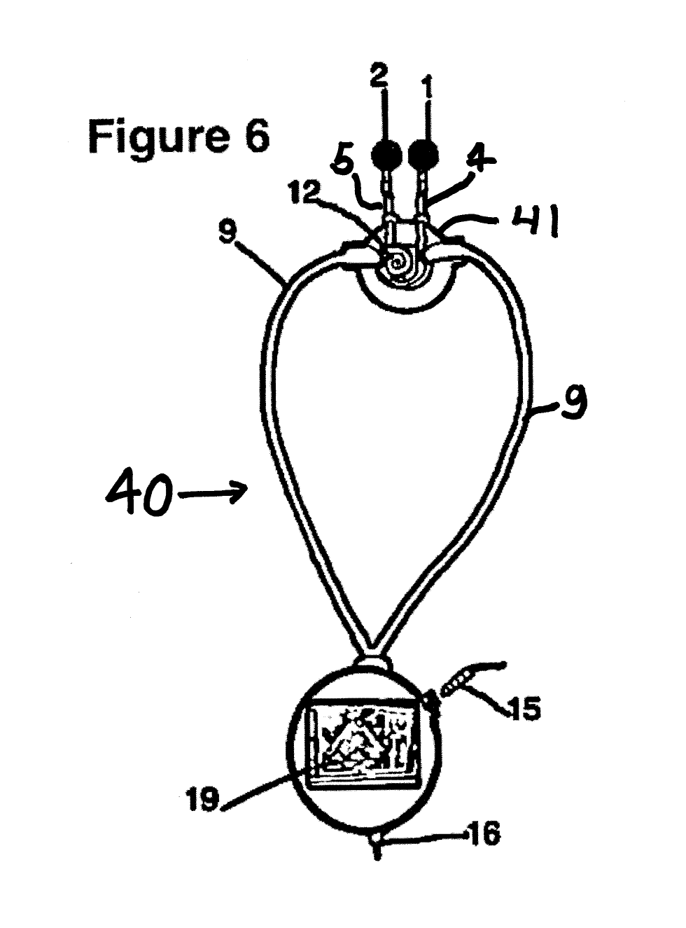

The mechanism 29 for receiving audio signals is provided with a connector 16, such as a headphone jack male connector, fixed to a retractable cable 13 that is retracted into the housing of the mechanism for receiving audio signal by a suitable spring loaded retractor mechanism as shown in FIG. 5c when the cable is not extended to be connected to a complementary port 31 of a device 32 such as an I Pod®, tablet computer, laptop computer, desktop computer or a cell phone as shown in FIG. 1. The retractable cable 13 is shown in a retracted configuration in FIG. 6 with the connector 16 left protruding from the housing of the mechanism for receiving audio signals. It is understood that the length of the cable or cord that is protracted from the device is locked to the selected length until a user of the device chooses to either have the cord or cable completely retracted into the device or to protract an even greater length of the cable or cord from the device.

If desired a signal splitter 14 is in signal conductive communication with a port 35 for receiving a complementary connector for a cable 15 from a second separate device (not shown) for transmitting sounds to at least one ear of a second listener. This feature allows the sharing of music with others without having to share earphones or earbuds. Incoming audio signals are transmitted to the signal conductors disposed in the lanyard 9. The lanyard 9 is held in a closed loop by the audio signal relay mechanism 41 that is fixed to the lanyard.

The lanyard 9 is intended to extend around the neck of a person with the audio signal relay mechanism 41 located behind the persons' neck and the mechanism 29 for receiving audio signals located on the front side of the person, that is to say resting on the persons' chest. The lanyard 9 has a length that will facilitate this configuration on a person, and if necessary devices provided with a variety of sizes of lanyards may be marketed to fill the needs of persons of various sizes. The lanyard is conveniently provided with a sound balance (right and left to the earphones/earbuds) and volume controller 22.

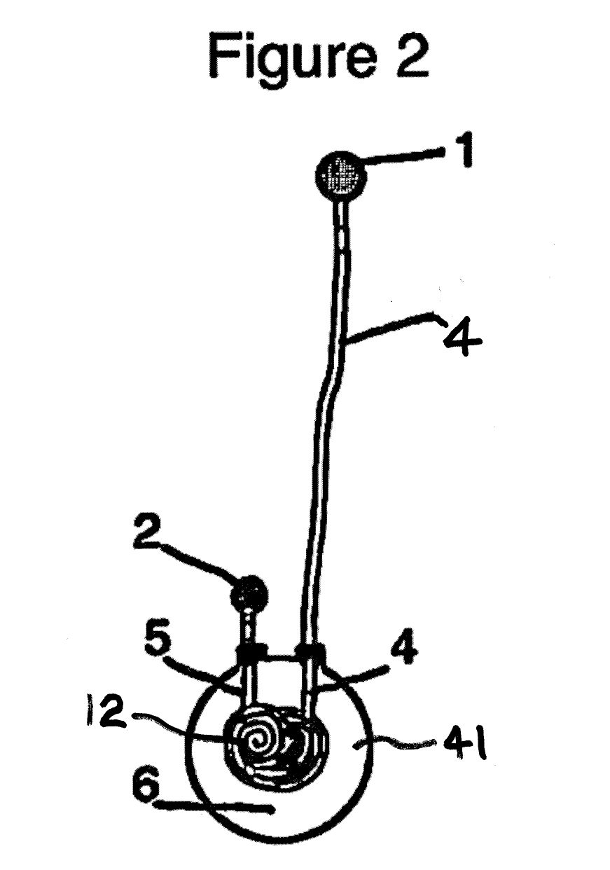

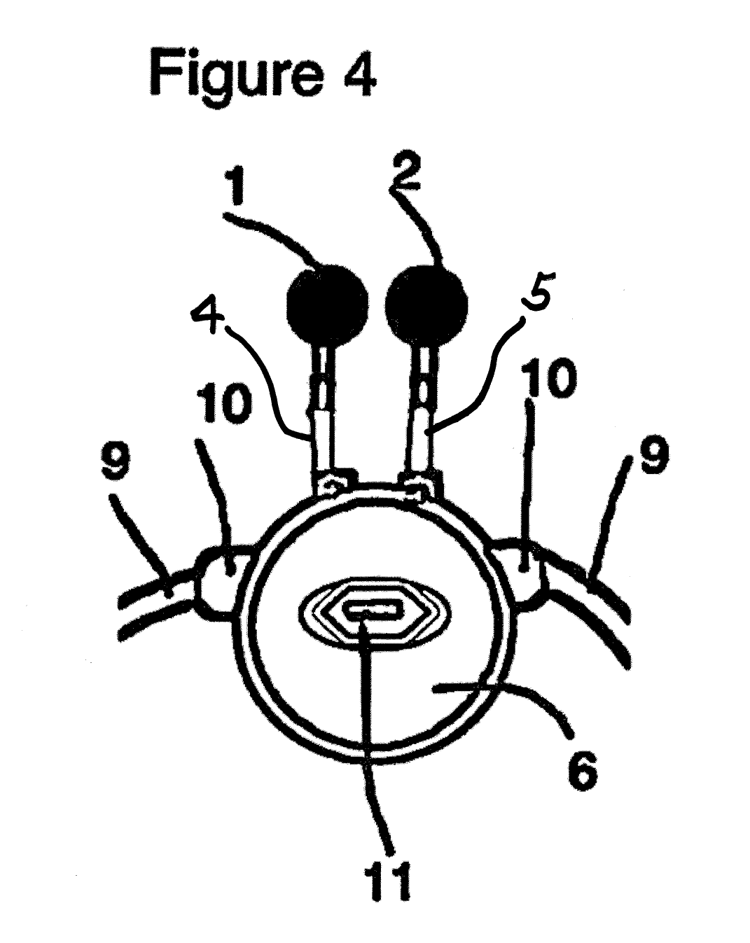

The audio signal relay mechanism 41 is best understood by referring to FIGS. 2, 4 and 6. The lanyard 9 with its associated audio signal conductors is provided with reinforced portions 10 adjacent the housing of the audio signal relay mechanism. As best shown in FIG. 4 on a wall 6 of the audio signal relay mechanism is a switch 11 to activate and terminate circuitry located in the audio signal relay mechanism such that in the event a person wearing the device has an incoming call on a cell phone connected by a cord or cable to the device the person can switch from hearing audio signals for a device such as an I Pod® to hearing the audio signals from an incoming telephone call without having to remove the earphones or earbuds. When the telephone call is completed the switch 11 can be pressed again to terminate the telephone call and return to listening to the audio signals from the device such as an I Pod®. The switch 11 is located on the side of the audio signal relay mechanism that is distal from a persons' neck when the person is wearing the device 40 of the present invention.

In FIGS. 4 and 6 the cables 4, 5 extending to the earphones 1, 2 are shown retracted back into the housing of the audio signal relay mechanism 41 by a suitable spring loaded cable retracting mechanism 12, best shown in FIG. 6 where part of the housing is removed to show this feature, that allows the earphones or earbuds to be retracted for storage when the device is not in use. Preferably, as best shown in FIG. 2, the cable retractor mechanism facilitates unilateral protraction of the cables to the earphones or earbuds so a person may chose to receive audio sounds in both of his ears, or only his right ear or only his left ear.

The device of the present invention provides a new practical and easy way to use earphones. Just slide the lanyard, having a total length of for example about thirty inches over a person's head, it should fit most people. The device is configured to have a compact, stylish and portable necklace design that keeps the cords/cable clutter to an absolute minimum with the cords/cables tangle-free.

The earphones have retractable cables/cords on both of the earphones/earbuds and also on the head jack cord. Simply pull to length desired and pull again to retract the cable/cord. This feature can stop cables/cords from being over extended or damaged. The unilateral design allows a user to use each ear bud/earplug individually and they stay put, don't hurt the ears and are easy to store since the automatic retracting takes care of the cable/cord. The cable/cord unwinds from a reel allowing the user to adjust how much cable/cord is flopping about, keeping things neat and tidy. This makes it simple to switch from a personal computer (PC) to any portable device. Being able to keep the cord clutter to an absolute minimum makes them tangle-free.

The device of the present invention is provided with a head jack cord of sufficient length, for example five feet, that allows an associated audio signal generating device to be located in any pocket of a user's apparel without the fear the user is going to tug and rip the cable/cord. This makes it easy to sit back and enjoy a movie on a home computer or while traveling. On the head jack cord the user can pull the cable/cord to a desired length and pull the cord again to retrieve the cable/cord. Examples of sound generating devices that may be employed with my new device includes, for example radios, cell phones, smart phones, personal computers of all varieties including tablet computers, compact disc players, video game systems, and so forth.

The device of the present invention is provided with a built in adapter to accurately transfer crispy clean sound with anyone that connects their earphones' head jack to the connector device. No more sharing ear buds/earplugs.

The device of the present invention can employ either earphones or earbuds, according to each user's preferences. The device is in the general configuration of a necklace, making the earphones/earbuds end up behind the neck. With an adequately long cable/cord, for example about ten inches the earphones/earbuds won't fall off with daily activities. The device of the present invention can be used in motionless relaxation or during furious workout, and they keep up with it all.

The device of the present invention is intended to provide warm bass and premium sound making it hands free. The device of the present invention may be provided with circuitry to provide that music will automatically pause at the occurrence of a selected event, such as a telephone call and then resume after the event is over.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense. It is also to be understood that the following claims are intended to cover all of the generic and specific features of the invention herein described, and all statements of the scope of the invention which, as a matter of language, might be said to fall therebetween.

What is claimed is:

1. A device for transmitting sounds to at least one ear of a listener comprising a mechanism for receiving audio signals from a device that generates audio signals, the mechanism for receiving audio signals being fixed to a lanyard that contains at least one conductor for conducting audio signals to an audio signal relay mechanism that relays the audio signals to audio signal conducting cables which communicate with devices that convert the audio signals into sounds that can be heard by a listener, the audio signal relay mechanism being provided with a mechanism for retraction and protraction of the audio signal conducting cables and the mechanism for receiving audio signals being provided with a mechanism for retraction and protraction of a cable provided with a connector for connection to a complementary port of the device that generates audio signals.

2. The device for transmitting sounds to at least one ear of a listener of claim 1 wherein the mechanism for receiving audio signals further comprises a signal splitter circuit and an associated port for receiving a cable from another device for transmitting sounds to at least one ear of a listener to allow a listener using the other device for transmitting sounds to at least one ear of a listener to hear the same sounds at the same time.

3. The device for transmitting sounds to at least one ear of a listener of claim 1 wherein the signal relay mechanism is provided with a mechanism for retraction and protraction of the audio signal conducting cables that facilitates retraction and protraction of the audio conducting cables either jointly or individually.

4. The device for transmitting sounds to at least one ear of a listener of claim 2 wherein the signal relay mechanism is provided with a mechanism for retraction and protraction of the audio signal conducting cables that facilitates retraction and protraction of the audio conducting cables either jointly or individually.

5. The device for transmitting sounds to at least one ear of a listener of claim 1 wherein the signal relay mechanism is provided with circuitry and a switch that switches an audio signal transmitted to devices that convert the audio signals into sounds that can be heard by a listener to either audio signals from one source of audio signals to another source of audio signals.

6. The device for transmitting sounds to at least one ear of a listener of claim 2 wherein the signal relay mechanism is provided with circuitry and a switch that switches an audio signal transmitted to devices that convert the audio signals into sounds that can be heard by a listener to either audio signals from one source of audio signals to another source of audio signals.

7. The device for transmitting sounds to at least one ear of a listener of claim 3 wherein the signal relay mechanism is provided with circuitry and a switch that switches an audio signal transmitted to devices that convert the audio signals into sounds that can be heard by a listener to either audio signals from one source of audio signals to another source of audio signals.

8. The device for transmitting sounds to at least one ear of a listener of claim 4 wherein the signal relay mechanism is provided with circuitry and a switch that switches an audio signal transmitted to devices that convert the audio signals into sounds that can be heard by a listener to either audio signals from one source of audio signals to another source of audio signals.

9. The device for transmitting sounds to at least one ear of a listener of claim 1 wherein the mechanism for receiving audio signals is provided with an ornamental article that can be removed and replaced with another ornamental article.

10. The device for transmitting sounds to at least one ear of a listener of claim 2 wherein the mechanism for receiving audio signals is provided with an ornamental article that can be removed and replaced with another ornamental article.

11. The device for transmitting sounds to at least one ear of a listener of claim 3 wherein the mechanism for receiving audio signals is provided with an ornamental article that can be removed and replaced with another ornamental article.

12. The device for transmitting sounds to at least one ear of a listener of claim 4 wherein the mechanism for receiving audio signals is provided with an ornamental article that can be removed and replaced with another ornamental article.

13. The device for transmitting sounds to at least one ear of a listener of claim 5 wherein the mechanism for receiving audio signals is provided with an ornamental article that can be removed and replaced with another ornamental article.

14. The device for transmitting sounds to at least one ear of a listener of claim 6 wherein the mechanism for receiving audio signals is provided with an ornamental article that can be removed and replaced with another ornamental article.

15. The device for transmitting sounds to at least one ear of a listener of claim 7 wherein the mechanism for receiving audio signals is provided with an ornamental article that can be removed and replaced with another ornamental article.

16. The device for transmitting sounds to at least one ear of a listener of claim 8 wherein the mechanism for receiving audio signals is provided with an ornamental article that can be removed and replaced with another ornamental article.
